(19) United States
(12) Patent Application Publication
(10) Pub. No.: US 2013/0311285 A1
(43) Pub. Date: Nov. 21, 2013

(54) APPS IN ADVERTISEMENTS

(71) Applicants: Sameer Abrol, Bothell, WA (US); Prem Prakash, Redmond, WA (US); Sriram K. Parameswar, Bellevue, WA (US); Vageesh Banga, Bothell, WA (US)

(72) Inventors: Sameer Abrol, Bothell, WA (US); Prem Prakash, Redmond, WA (US); Sriram K. Parameswar, Bellevue, WA (US); Vageesh Banga, Bothell, WA (US)

(73) Assignee: MICROSOFT CORPORATION, Redmond, WA (US)

(21) Appl. No.: 13/475,425

(22) Filed: May 18, 2012

(51) Int. Cl. G06Q 30/02; G06F 17/30

(52) U.S. Cl. 705/14.54

(57) ABSTRACT

Systems and methods for responding to a search query from a user are presented. In responding to a search query from a user, the user is presented with a search results page. The search results page includes both search results (relevant to the search query) and one or more advertisements. At least one of the advertisements is a specially configured advertisement that includes a corresponding app. Execution of the app is initiated through a user-actionable control in the advertisement. Unlike other advertisements that cause navigation to an advertisers landing page, the corresponding app executes within the context of the browser view/search results page. The corresponding app may be designed so that a transaction may be completed through its execution (the particular transaction depending upon the design of the app.)

### BACKGROUND

Advertisements are, currently, the lifeblood of many “free” online services, including many search engines. In response to receiving a search query from a user, the search engine generates a search results page that includes one or more advertisements. Of course, advertisers want to target their advertisements (and, correspondingly, their advertising budget) to those users who are most likely to engage the services or purchase the products of the advertiser. This desire was a primary motivator in moving search engines from charging advertisers on a CPM (cost per 1000 impressions) basis to a CPC (cost per click) basis. While, for the advertiser, the CPC model is a substantial improvement over the CPM model, a click-through on an advertisement (which generates an advertisement charge to the advertiser by the search engine) takes the user to the advertiser's landing page but does necessarily translate into a transaction where the user purchases (or otherwise engages) the advertisers products/services. Even though an advertiser would be more inclined to pay more for advertisements when the user engages with or completes a transaction with the advertiser, search engine providers are, naturally, reluctant to operate on this basis since the search engine provider would need to rely entirely on the advertiser to report whether or not a transaction was completed.

### SUMMARY

According to embodiments of the disclosed subject matter, a method for responding to a search query from a user is presented. In this embodiment, in responding to receiving a search query from a user, the user is presented with a search results page. The search results page includes both search results (relevant to the search query) and one or more advertisements. At least one of the advertisements is a specially configured advertisement that includes a corresponding app. The app is initiated through a user-actionable control in the advertisement. Unlike other advertisements that cause navigation to an advertisers landing page, the corresponding app executes within the context of the browser view/search results page. The corresponding app may be designed so that a transaction may be completed through its execution (the particular transaction depending upon the design of the app.)

According to additional embodiments of the disclosed subject matter, computer-readable media bearing computer-executable instructions are presented. When executed on a computer, the instructions carry out a method for responding to a search query from a user is presented. In this embodiment, in responding to receiving a search query from a user, the user is presented with a search results page. The search results page includes both search results (relevant to the search query) and one or more advertisements. At least one of the advertisements is a specially configured advertisement that includes a corresponding app. The app is initiated through a user-actionable control in the advertisement. Unlike other advertisements, the corresponding app executes within the context of the browser view/search results page. The corresponding app may be designed so that a transaction may be completed through its execution (the particular transaction depending upon the design of the app.)

According to still further embodiments of the disclosed subject matter, a computer system for presenting search results responsive to a search query is presented. The computer system includes a processor and a memory. The processor executes instructions obtained from memory and, in conjunction with additional components of the computer system respond to a user's search query. The additional components include, but are not limited to: a search results retrieval component for obtaining search results from a content index in response to the search query; a network communication component that enables communication between a user computer and the computer system; an advertisement services component for selecting advertisements to be incorporated in a search results page in response to the search query; and a search results page generator that generates a search results page responsive to the search query based on the search results and advertisements obtained by the other components, and returns the generated search results page to the user via the network communication component. One or more of the advertisements includes is an advertisement that includes a user-actionable control for executing a corresponding app within a user's browser context.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an exemplary network environment suitable for implementing aspects of the disclosed subject matter;

FIGS. 2A and 2B are pictorial diagrams illustrating a first example of an app within an advertisement on a search results page;

FIGS. 3A and 3B are pictorial diagrams illustrating a second example of an app within an advertisement on a search results page;

FIGS. 4A and 4B are pictorial diagrams illustrating a third example of an app within an advertisement on a search results page;

FIG. 5 a flow diagram illustrating an exemplary routine for responding to a search query with a search results page that includes at least one advertisement including a corresponding app;

FIG. 6 is a flow diagram illustrating an exemplary routine for displaying a search results page to a user and responding to a user click on an advertisement having a corresponding app;

FIG. 7 is block diagram illustrating exemplary components of search engine configured to respond to a search query with a search results page that includes search results and one or more advertisements, including at least one advertisement that has a corresponding app;

FIG. 8 is a pictorial diagram illustrating the use of an app services framework by an app in the context of a browser view.

FIG. 9 is a pictorial diagram illustrating an exemplary browser view including at least one example of an embedded app.

### DETAILED DESCRIPTION

For purposed of clarity, the use of the term “exemplary” in this document should be interpreted as serving as an illustration or example of something, and it should not be interpreted as an ideal and/or leading illustration of that thing.

For purposes of clarity, a “search result” is data presented to a user in response to a search query from the user. Typically, a search result is a reference (or hyperlink) to content accessible to the user over a network. A search results page is a displayable collection of information generated by a search engine in response to a search query. One or more search results pages may result from a single search query. A search results page will include search results as well as advertisements. The search engine (alone or in combination with an ad selection service) will select one or more advertisements for each search results page. As will be discussed further, according to aspects of the disclosed subject matter, some of these advertisements may include apps that, if initiated by a user, will operate in conjunction with a service framework enabled through the search results page.

By way of definition for this disclosure, an “app” corresponds to an executable module that is associated with an advertisement. In general, an app is distinguished from an application program in that an “app” is an executable module designed to carry out a specific purpose. In addition to being devoted to a specific purpose, apps embedded or included with advertisements are often small in size (especially when compared with traditional application programs) as they are downloaded over the network, often at the time that a user activates the user-actionable control to initiate the app's execution.

Often, an app is reliant upon the presence of a service framework in order to operate. Apps may be written in any number of languages (including scripting languages) such as, but not limited to, C#, Java, JavaScript, AJAX, Flash, and Silverlight. According to aspects of the disclosed subject matter, as an app operates in conjunction with the service framework enabled through the search results page, the app executes within the context of the browser window that displays the search results page. Even so, an app may rely upon data and/or services that operate externally to the browser and/or user computing device, such as accessing data from a service operating at a remote networked location. An app is associated with an advertisement in that the app is embedded or included within, hosted by, or presented by the advertisement. Further still, the user-actionable control/mechanism for launching the app is similarly embedded or included within, hosted or by, or facilitated through the advertisement.

In regard to the user-actionable control that initiates or launches an app ebbed in (or otherwise associated with) an advertisement, while examples in the figures and description below suggest the use of a clickable button (though the use of a mouse or other pointing device), this is illustrative of one particular user-interaction paradigm and should not be construed as limiting upon the disclosed subject matter. User-actionable controls also include, but are not limited to, voice activated controls, touch-based controls (including touch, circling and/or other gesture based controls), other natural user interface (NUI) controls, and the like.

According to aspects of the disclosed subject matter, responsive to a search query a search engine will generate one or more search results pages. In addition to the search results in the search results pages, also included are advertisements, some of which include an app. A user can activate the app to interact with its features. As will be discussed further below, one of the features of the app (a key feature) is to complete a transaction. As a user completes a transaction, the advertiser is charged a transaction cost by the search engine. This “transaction cost” charged by the search engine is an advertising cost associated with the completion of the transaction, and is not the cost that the user may incur for completing the transaction.

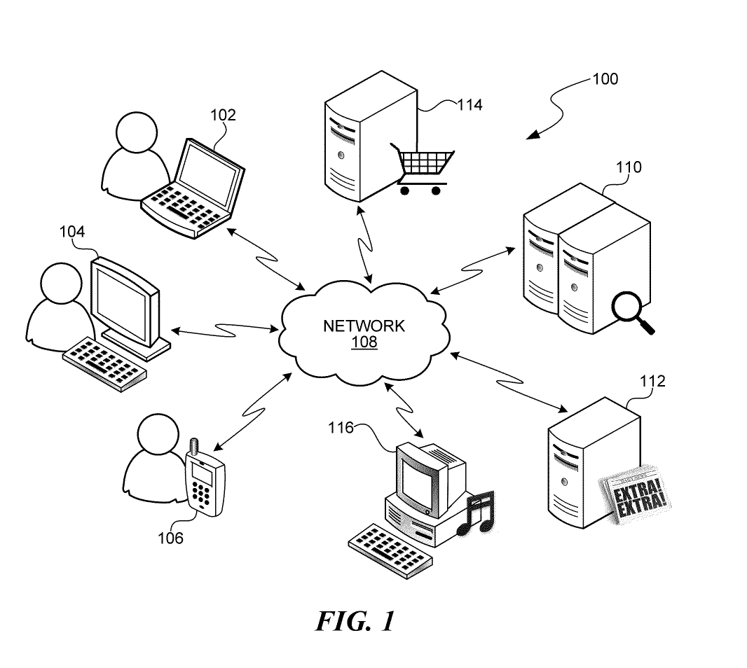

Turning now to the figures, FIG. 1 is a pictorial diagram illustrating an exemplary network environment 100 suitable for implementing aspects of the disclosed subject matter. The illustrative environment 100 includes one or more user computers, such as user computers 102-106, connected to a network 108, such as the Internet, a wide area network or WAN, and the like. Also connected to the network 108 is a search engine 110 configured to provide search results in response to a computer user's search query, including annotated search results.

Those skilled in the art will appreciate that a search engine 110 corresponds to an online search service hosted on one or more computers on, or computing systems distributed throughout, the network 108. Generally speaking, the search engine 110 is configured to receive and respond to search queries submitted over the network 108 from various users, such as the users connected to user computers 102-106. As already mentioned, in response to receiving a search query, the search engine 110 obtains search results information related and/or relevant to a user's search query (as defined by the terms of search query.) The search results are typically references (largely in the form of hyperlinks) to relevant/related content available from various target sites (such as target sites 112-116) on the network 108. The search results may also include other information such as related and/or recommended alternative search queries, data and facts regarding the subject matter of the search query, products, and/or services related/relevant to the search query, and the like. Also included with the search results are advertisements, including advertisements that include apps. These advertisements are selected by the search engine 110 or in conjunction with an advertisement service (not shown). The search engine 110 generates one or more search results pages responsive to the search query based on the search results information. The search results pages include the selected advertisements.

As those skilled in the art will appreciate, target sites, such as target sites 112-116, host content that is available and/or accessible to users (via user computers) over the network 108. The search engine 110 will be aware of at least some of the content hosted on the many target sites located throughout the network 108, and will store information regarding the hosted content of the target sites in a content index. The search engine 110 draws from the content index when obtaining search results in response to receiving a search query. As shown in FIG. 1, the target sites include, by way of illustration, a news organization 112, a shopping site 114, and an online music service 216. Of course, those skilled in the art will appreciate that any number and type of target sites may be connected to the network 108. Moreover, as is known in the art, some search engines are aware of millions of target sites and the content that is hosted by those target sites.

In addition to hosting content, the target sites may also be advertisers and offer advertisements that include apps. For example, the shopping site 114 may be advertising a particular brand of item offered at its site, and the corresponding advertisement may include an app that enables a user to identify particular items and conclude a purchase of the particular item—all without leaving the context of the current search results page. Advantageously, because the search engine 110 provides the framework through which the transaction is conducted and can, therefore, track the transactions, the search engine (or its counterpart advertising service) is able to work with advertisers on a cost-per-transaction basis, i.e., charging the advertiser upon the completion of a transaction.

Suitable user computers for operating within the illustrative environment 100 include any number of computing devices that can communicate with the search engine 110 or target sites 112-116 over the network 108. In regard to the search engine 110, communication between the user computers 102-106 and the search engine 110 include both submitting search queries and receiving a response in the form of one or more search results pages from the search engine 110. User computers 102-106 may communicate with the network 108 via wired or wireless communication connections. These user computers 102-106 may comprise, but are not limited to: laptop computers such as user computer 102; desktop computers such as user computer 104; mobile phone devices such as user computer 106; tablet computers (not shown); on-board computing systems such as those found in vehicles (not shown); mini- and/or main-frame computers (not shown); and the like.

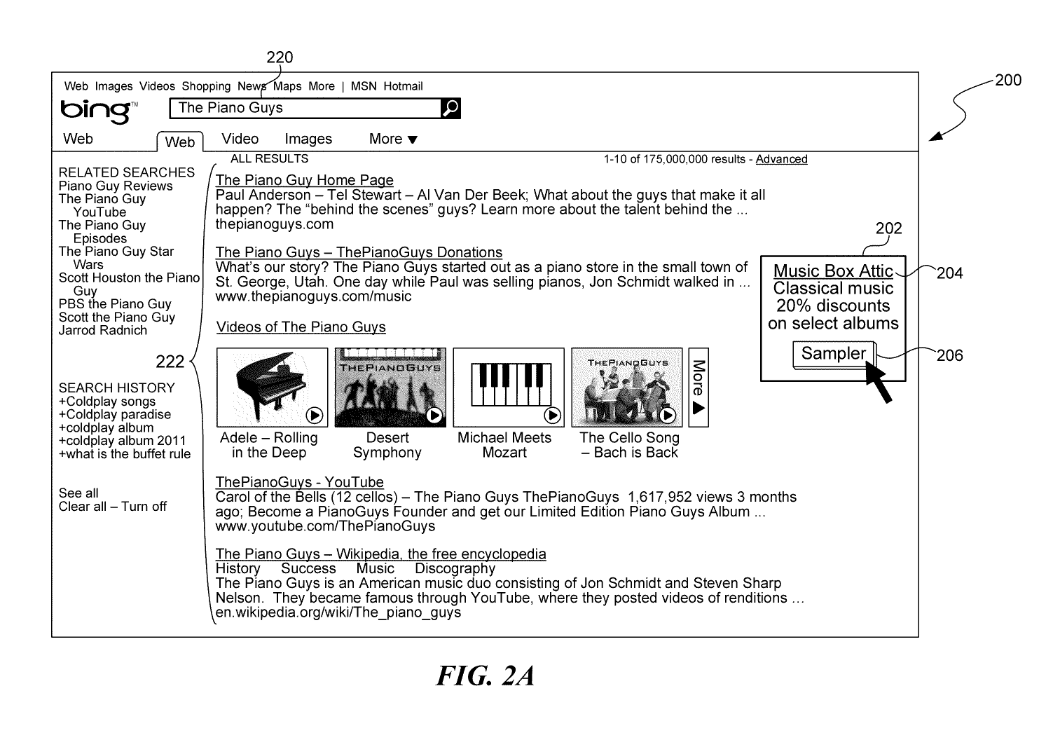

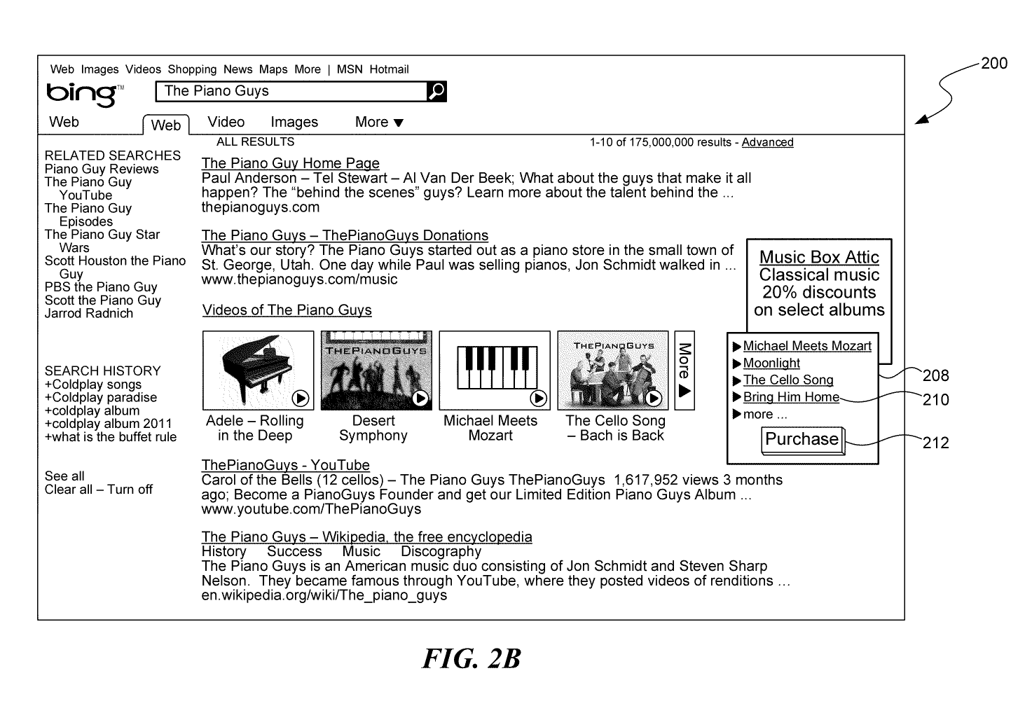

Turning now to FIGS. 2A and 2B, these figures are pictorial diagrams illustrating an example of an app within and advertisement. More particularly, FIG. 2A illustrates an exemplary browser view of a portion of a search results page 200 responsive to the search query 220 “The Piano Guys.” In addition to the search results 222, the search results page 200 includes an advertisement 202. As is common, the advertisement includes an advertiser link 204 to the advertisers landing page and also includes a user-actionable control 206 associated with an app. As shown in FIG. 2b, in this example, the user-actionable control 206 initiates a sampler app 208 in which the user can listen to all or portions of selected songs (such as “Bring Him Home” 210), and also enables the user to purchase the songs and/or album through control 212.

In the example shown via FIGS. 2A and 2B, the “transaction” upon which the search engine 110 will charge the advertiser on the cost-per-transaction basis may be the activation of the sampler app 208 or the purchase of one or more songs via control 212. Alternatively, simply activating the sampler app 208 may incur a first cost whereas the user's purchase of the proffered items may include a second cost, i.e., differential costs for different transactions. Still further, the search engine 110 may be further configured to charge the advertiser corresponding to advertisement 202 on a cost-per-click basis if the user simply clicks through to the advertiser's landing page (such as by clicking on link 204.)

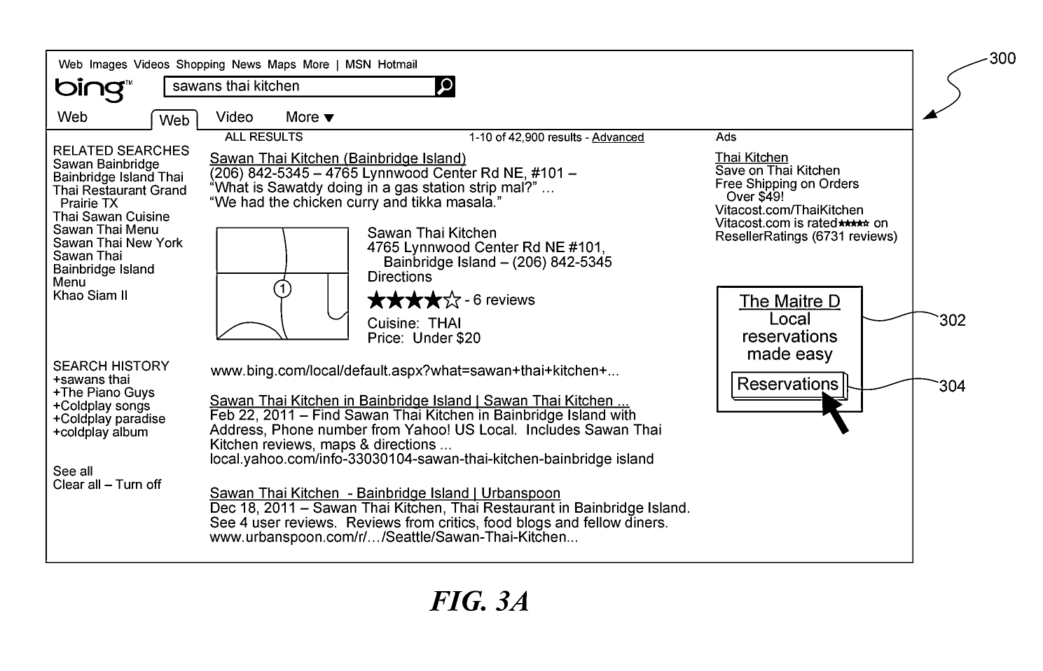

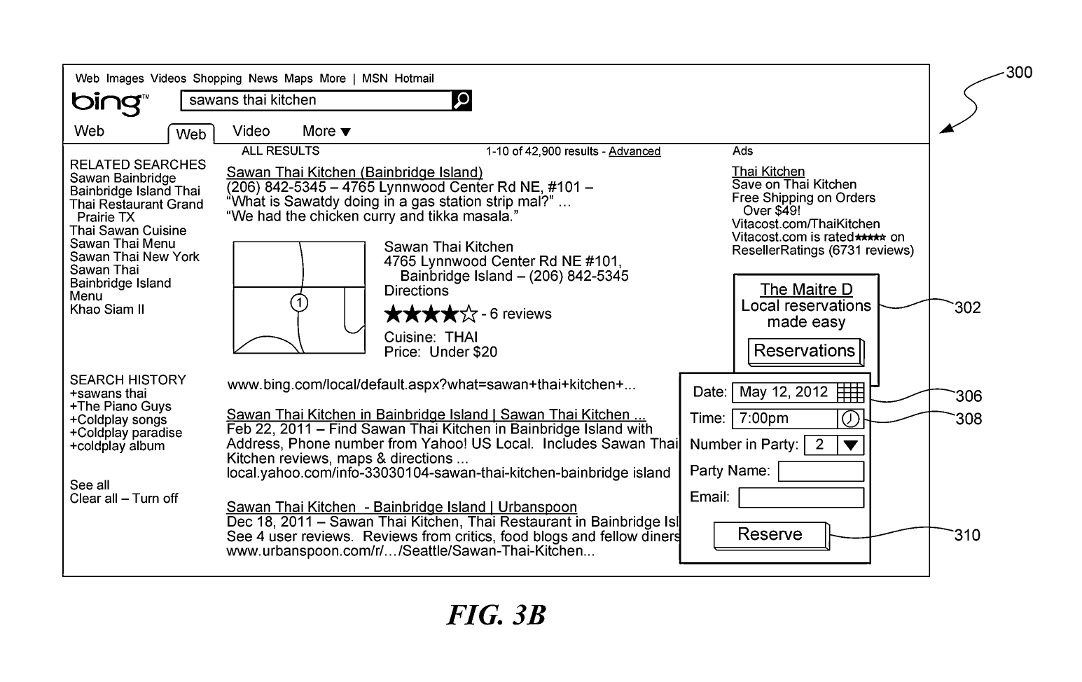

FIGS. 3A and 3B are pictorial diagrams illustrating a second example of an app within an advertisement on a search results page. In this example, FIG. 3A illustrates an exemplary browser view of a portion of a search results page 300 responsive to the search query 320 “Sawans Thai Kitchen.” Several advertisements are included in the search results page with the corresponding search results, including advertisement 302 that includes a user-actionable control 304 for initiating the corresponding app, in this case a reservation app. As shown in FIG. 3B, the corresponding reservation app 306 enables the user to make a reservation for the particular restaurant with details such as the date of the reservation, the time 308 for the reservation, and other details that are normally included with a reservation, and a user-actionable control 310 to place the reservation for the restaurant through the advertiser.

In this example of FIGS. 3A and 3B, the “transaction” upon which the search engine 110 will charge the advertiser on a cost-per-transaction basis may be the activation of the reservation app 306 or by placing the reservation via the reservation control 310. Of course, differential pricing may be implemented depending on whether the user simply activating the reservation app 208 or whether the user places a reservation. Still further, just as with the example of FIGS. 2A and 2B, the search engine 110 may be further configured to charge the advertiser corresponding to advertisement 302 on a cost-per-click basis if the user simply clicks through to the advertiser's landing page.

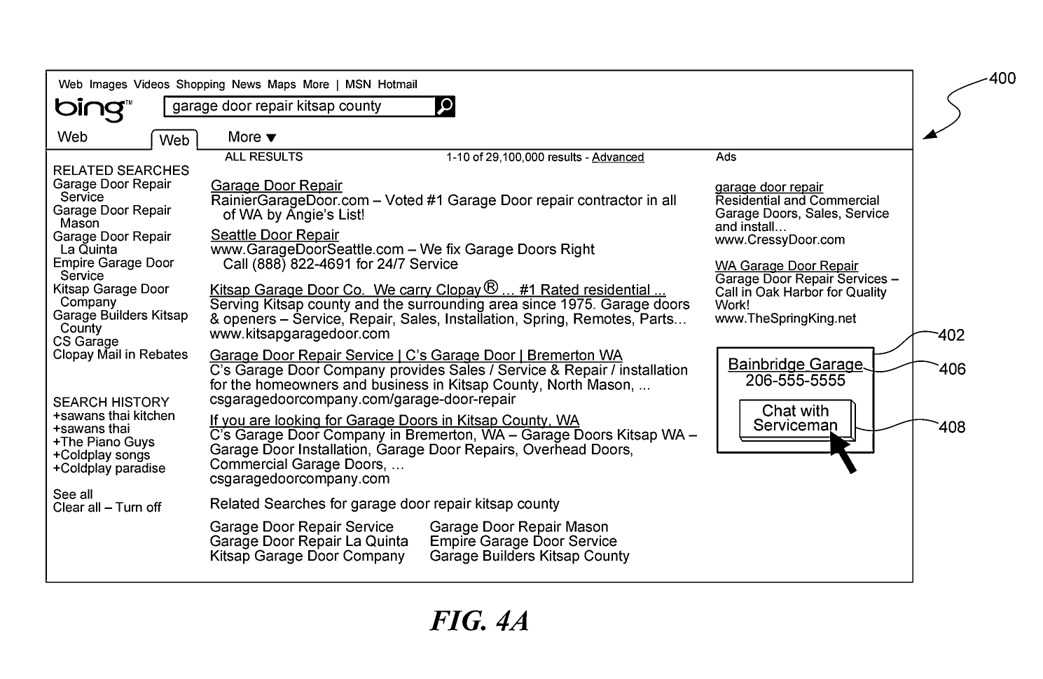

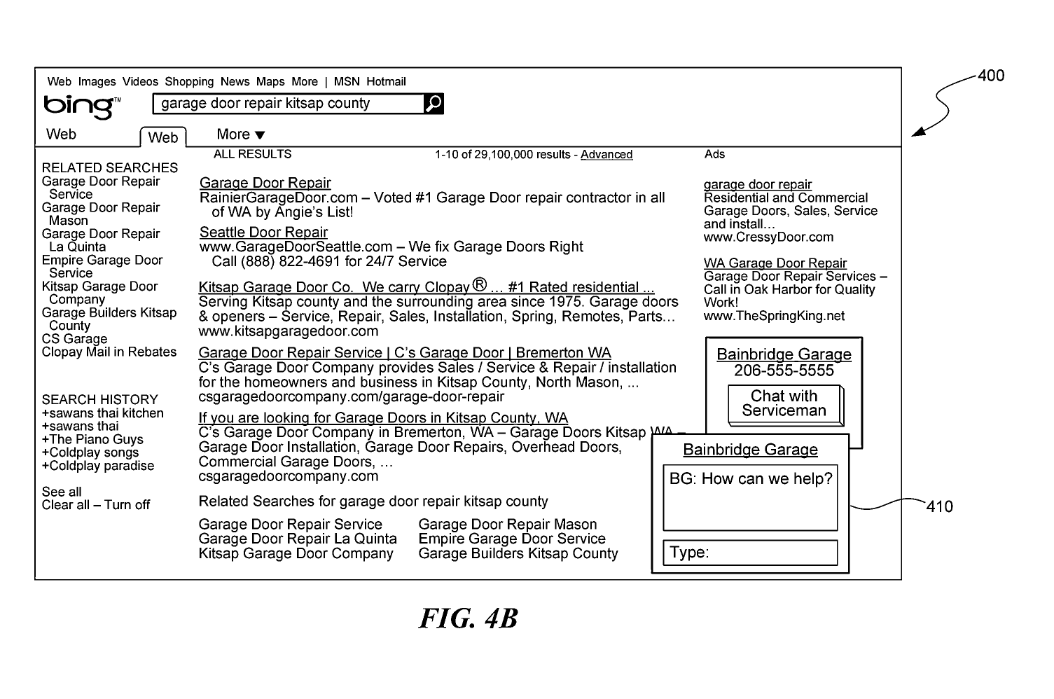

FIGS. 4A and 4B are pictorial diagrams illustrating a third example of an app within an advertisement on a search results page. In this example, FIG. 4A illustrates an exemplary browser view of a portion of a search results page 400 responsive to the search query 420 “Garage Door Repair.” Several advertisements are included in the search results page with the corresponding search results, including advertisement 402 that includes a user-actionable control 408 for initiating the corresponding app, in this case an app that establishes a communication channel with a service person. As shown in FIG. 4B, the corresponding communication app 410 hosts a communication channel (in this case a chat window) with the advertising service.

In the example represented by FIGS. 4A and 4B, the “transaction” upon which the search engine 110 will charge the advertiser on a cost-per-transaction basis would be the establishment of a communication channel with the advertising service via the user-actionable control 408. Of course, just as with the example of FIGS. 2A and 2B and FIGS. 3A and 3B, the search engine 110 may be further configured to charge the advertiser corresponding to advertisement 402 on a cost-per-click basis if the user simply clicks through to the advertiser's landing page.

As can be seen by the examples above, in the present context a “transaction” does not necessarily mean a purchase or financial transaction. For many advertisers, a “transaction” is completed when the user interacts with the advertiser's app, when the user provides sought-for information or completes a particular task, or completes a purchase. Examples of other “transactions” may include, but is not limited to, establishing a personal preference to a particular vendor, subscribing to a newsletter or blog, creating a personal account with the advertiser, providing personal information (such as an email account), and the like.

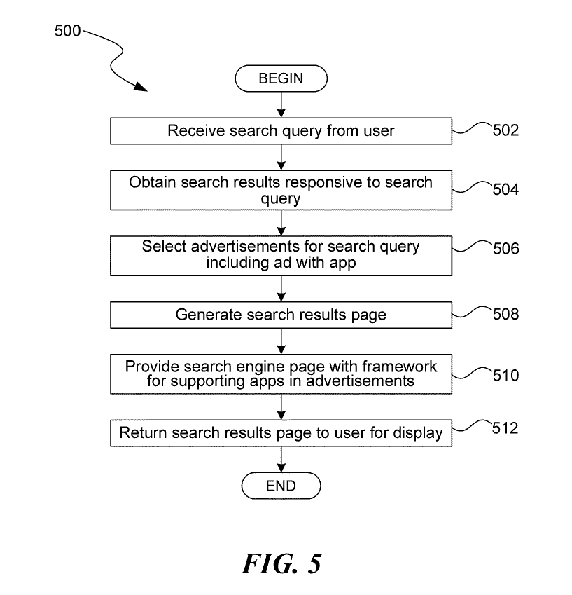

Turning now to FIG. 5, this figure is of a flow diagram illustrating an exemplary routine 500 for responding to a search query with a search results page that includes at least one advertisement including a corresponding app. At block 502, the search engine 110 receives a search query from a user. At block 504, the search engine obtains search results responsive to the search query. At block 506, the search engine 110 (or a cooperating related advertisement service) selects one or more advertisements to be included in a search results page responsive to the search query from the user. According to aspects of the disclosed subject matter, the one or more selected advertisements include at least one advertisement that includes a corresponding app. At block 508, the search engine generates a search results page based on the obtained search results and the one or more selected advertisements. At block 510, the search engine includes data within the search results page that enables apps within advertisements to access a framework of services for supporting the apps. At block 512, the search engine 110 returns the generated search results page to the user for presentation to the user in a browser view.

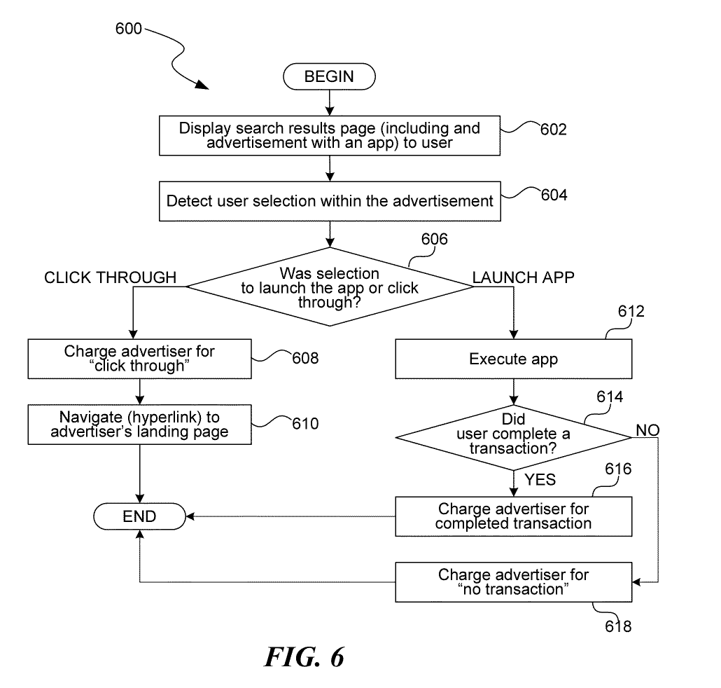

Turning now to FIG. 6, this figure illustrates an exemplary routine 600 for displaying a search results page to a user and responding to a user click on an advertisement having a corresponding app. Beginning at block 602, the search results page received from the search engine 110 is displayed to the user in the user's browser view. According to aspects of the disclosed subject matter, this search results page includes at least one advertisement having a corresponding app. At block 604, a user selection, such as a mouse click, is detected within the advertisement having the corresponding app.

At decision block 606, the determination is made as to whether the user selection/click was to launch the corresponding app or simply whether the user desires to click through to the advertiser's landing page. As discussed above, the control is typically provided to the user such that the user can initiate an app. However, like clicking on the advertisement but not on the control corresponding to the app a user can “click through” to the advertiser's landing page as is customary in the art. Accordingly, if the user selection was simply a “click through” selection, at block 608, the advertiser is charged for the click through according to a typical CPC model. At block 610, the hyperlink is followed to the advertiser's landing page. Thereafter, the routine 600 ends.

Alternatively, if at decision block 606 the user selection/click was to launch the corresponding app, the routine 600 proceeds to block 612. At block 612, the corresponding app that the user selected is executed with in the context of the browser view. Execution of the app continues until at some point a determination can be made as to whether the user completed a transaction. In one embodiment, this occurs when the app closes its execution.

As discussed above, a transaction does not necessarily mean a financial transaction or purchase but, rather, implies achieving the goal of executing the app. If, at decision block 614, the user completed a transaction (as defined by the goal of the app), the routine 600 proceeds to block 616. At block 616, the advertiser is charged for a completed transaction under the CPT model. In at least one embodiment, the charge to the advertiser for the completed transaction also includes a charge for a click representing a hybrid CPC/CPT model. Thereafter, the routine 600 terminates.

Returning again to decision block 614, if the user did not complete a transaction, the routine 600 proceeds to block 618 where the advertiser is charged for a “no” transaction. In one embodiment, a “no transaction” may mean that the advertiser is charged for the amount corresponding to a click. Alternatively, if the user fails to complete a transaction, the advertiser may be charged a “no transaction” charge. According to various embodiments, this “no transaction” charge may be substantially less than a completed transaction charge but could be more than a “click” charge. After charging the advertiser a “no transaction” the, the routine 600 terminates.

As those skilled in the art will appreciate, routines or methods, such as routines 500 and 600, are described in terms of steps to carry out the functionality of the disclosed subject matter. It should be appreciated, however, that the steps identified in these routines are logical steps and may or may not correspond to actual steps carried out in an actual implementation of the disclosed subject matter. Moreover, those skilled in the art will appreciate that the individual steps, themselves, are often comprised of many discrete instructions. On a suitably configured computer or computing device, these instructions are retrieved from a memory/instruction store and executed by a processor. Execution of these instructions may or may not be carried out in conjunction with other physical and/or logical components of the computer.

While various aspects of the disclosed subject matter are expressed as steps in routines or methods, the functionality of these various aspects may also be embodied in computer-readable media. As those skilled in the art will appreciate, computer-readable media can host computer-executable instructions for later retrieval and execution, including instructions for carrying out the functionality of the subject matter disclosed in this document. When executed by a processor on a computing device, the computer-executable instructions carry out various steps or methods. In this regard, computer-readable media may serve as the memory/instruction store mentioned above. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage service); and the like. While it is possible to execute instructions obtained via carrier waves and/or propagated signals, for purposes of this document, computer-readable media expressly excludes carrier waves and propagated signals.

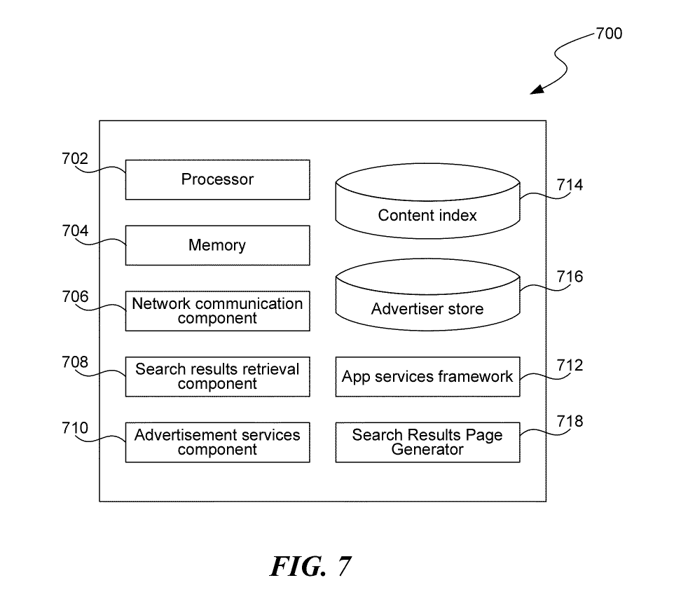

Turning now to FIG. 7, this figure is of a block diagram illustrating exemplary components of search engine 110 configured to respond to a search query with a search results page that includes search results and one or more advertisements, including at least one advertisement that has a corresponding app. As shown, the exemplary search engine 110 includes a processor 702 and a memory 704. As those skilled in the art will appreciate, the processor 702 executes instructions retrieved from memory 704 in carrying out various aspects of the search engine service, including responding to search queries with search results and one or more advertisements, including at least one advertisement that includes a corresponding app.

The search engine 110 also includes a network communications component 706 through which the search engine 110 sends and receives communications over the network 108. For example, it is through the network communication component 706 that the search engine 110 receives search queries from users in the user computers, such as user computers 102-106, and returns one or more search results pages responsive to the search queries. The search engine 110 also includes additional components such as, but not limited to: a search results retrieval component 708; an add services component 710; an advertisement store 716; a content index 714; a page generation component 718; and an app services framework 712. Regarding these additional components, it should be appreciated that these should be viewed as logical components for carrying out various functions of suitable configured search engine 110. These logical components may or may not correspond directly to actual and/or physical components. Moreover, in an actual embodiment, these components may be combined together or broke up across multiple actual components.

The search results retrieval component 708 retrieves and/or obtains search results relevant to a user's search query from the content index 714. The content index 714 is something of a misnomer in that for many search engines this index typically stores references to content, not the content itself. However, the content index 714 is not limited to storing just references to content and may also store the actual content. The advertisement services component 710 (which may be part of the search engine 110 as illustrated in FIG. 7 though, alternatively, may be implemented as a cooperating, yet distinct, service) selects one or more advertisements to be included in a search results page responsive to the user's search query. According to aspects of the disclosed subject matter, at least one advertisement selected for inclusion in a search results page is an advertisement that includes a corresponding app. The advertisement services component 710 selects the one or more advertisements from an advertisement store 716.

Also included in the illustrated search engine 110 is a search results page generator 718. The search results page generator 718 generates one or more search results pages from the obtained search results and the selected advertisements. Also included (or referenced) in the generated search results pages is the app services framework 712. The app services framework 712 provides the services that each app within an advertisement relies upon to execute within the browser view context.

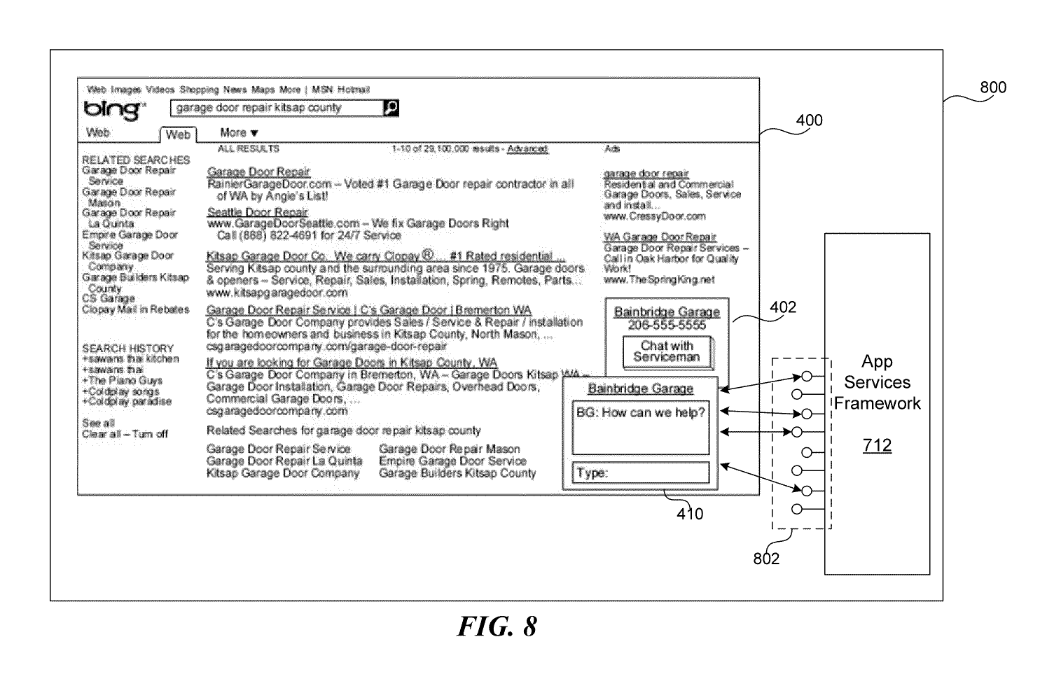

As mentioned above, the app services framework is included in a search results page or made available through the search results page to any apps within advertisements. FIG. 8 is a pictorial diagram illustrating the use of the app services framework 712 by an app in the context of a browser view 800. In particular, this diagram illustrates the exemplary search results page 400 with the communication app 410 executing (as described above in regard to FIG. 4). Also shown as part of the browser view context 800 is the app services framework 712. The app services framework 712 includes a plurality of interfaces 802 through which each app included in an advertisement, such as communication app 410 in advertisement 402, access the services provided by the app services framework. The bi-directional lines between the interfaces 802 and the communication app 410 illustrate that this, as well as any other, may call any or all of the interfaces provided by the app services framework 712, each depending on the app's own requirements.

Though the exemplary browser context 800 illustrates just the search results page 400 and the app services framework 712, those skilled in the art will appreciate that there are many other components, both logical and actual, to the browser view context. The discussion was limited to the search results page 400 and the app services framework 712 for clarity of discussion.

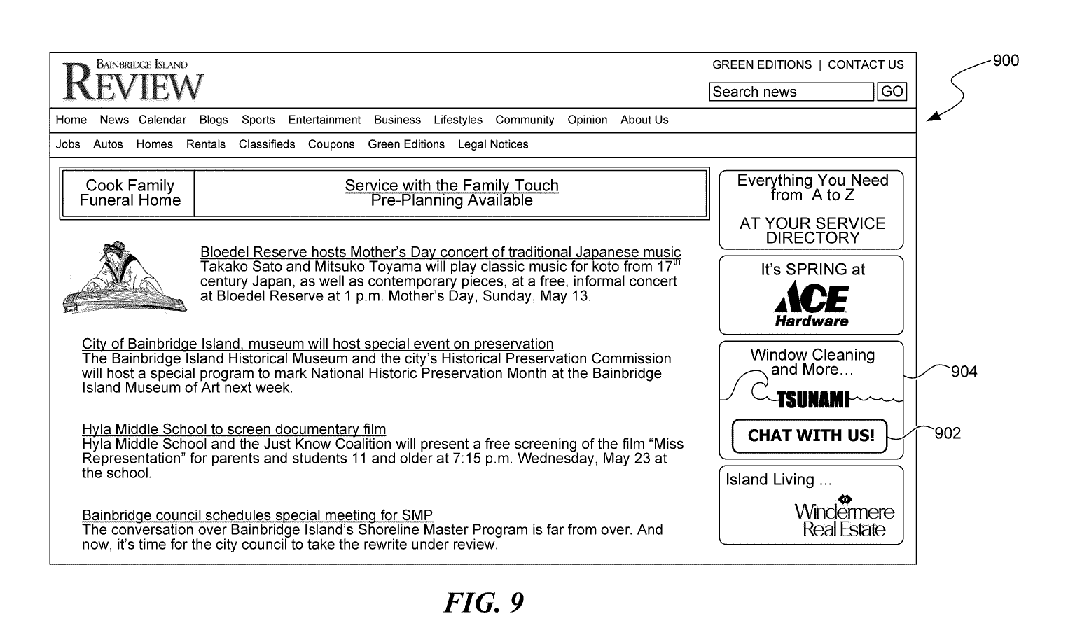

While much of the description regarding embedding or including an app within an advertisement, the disclosed subject matter is not so limited. In various alternative embodiments, an advertisement displayed in conjunction with a Web page may include an embedded app. FIG. 9 is a pictorial diagram illustrating an exemplary browser view 900 including at least one example of an embedded app, as signified by user control 902, within an advertisement 904. The corresponding services framework may be provided by the hosting web page or by the browser, with the effect that the corresponding app executes within the context of the Web page (or browser) view.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a user, the method comprising:
providing a search results page within a browser view in response to a search query from a user, the search results page comprising a plurality of search results relevant to the search query and an advertisement from an advertiser;
wherein the advertisement includes a user-actionable control for executing a corresponding executable app within the browser view.

2. The method of claim 1, wherein the search results page includes an app services framework providing a plurality of executable services for supporting the execution of the executable app.

3. The method of claim 2 further comprising detecting a user activation of the user-actionable control and executing the corresponding executable app within the browser view.

4. The method of claim 3, further comprising detecting the completion of a transaction between the user and the advertiser in the execution of the executable app.

5. The method of claim 4 further comprising charging the advertiser a completed transaction charge.

6. The method of claim 2 further comprising detecting the termination of the execution of the executable app without the completion of a transaction between the user and the advertiser in the execution of the executable app.

7. The method of claim 6 further comprising charging the advertiser a “no transaction” charge for the execution of the executable app without a transaction.

8. A computer-readable medium bearing computer-executable instructions which, when executed on a computing system comprising at least a processor retrieved from the medium, carry out a method for responding to a search query from a user, the method comprising:
receiving a search query from a user and obtaining a search results page responsive to the search query, wherein the search results page includes a plurality of search results relevant to the search query and further includes a plurality of advertisements, wherein the plurality of advertisements includes at least one advertisement that includes a user-actionable control for executing a corresponding executable app within a browser view; and
displaying the search results page within a browser view in response to a search query from a user.

9. The computer-readable medium of claim 8, wherein the search results page includes an app services framework providing a plurality of executable services for supporting the execution of the executable app.

10. The computer-readable medium of claim 9, wherein the method further comprises detecting a user activation of the user-actionable control and executing the corresponding executable app within the browser view.

11. The computer-readable medium of claim 10, wherein the method further comprises further comprising detecting the completion of a transaction between the user and the advertiser in the execution of the executable app.

12. The computer-readable medium of claim 11, wherein the method further comprises comprising charging the advertiser a completed transaction charge.

13. The computer-readable medium of claim 8, wherein the method further comprises detecting the termination of the execution of the executable app without the completion of a transaction between the user and the advertiser in the execution of the executable app.

14. The computer-readable medium of claim 13, wherein the method further comprises charging the advertiser a “no transaction” charge for the execution of the executable app without a transaction.

15. A computer system for presenting search results responsive to a search query, the system comprising a processor and a memory, wherein the processor executes instructions stored in the memory as part of or in conjunction with additional components to respond to a search query, the additional components comprising:
a search results retrieval component for obtaining search results from a content index in response to receiving a search query over a network communication component;
an advertisement services component for selecting one or more advertisements from an advertiser store to be incorporated in a search results page in response to the search query, wherein the one or more advertisements includes at least one advertisement that includes a user-actionable control for executing a corresponding app within a user's browser context; and
a search results page generator that generates a search results page responsive to the search query and returns the generated search results page to the user via the network communication component, wherein the generated search results page includes at least some of the obtained search results and the at least one advertisement that includes the user-actionable control for executing an app within a user's browser context.

16. The computer system of claim 15, wherein the search results page generator generates the search results page such that the corresponding app of the at least one advertisement has access to an app services framework that provides services that support the execution of the corresponding app.

17. The computer system of claim 15, wherein the generated search results page is configured to enable detection when execution of the corresponding app is initiated.

18. The computer system of claim 17, wherein the generated search results page is configured to enable detection of a completion of a transaction between the user and an advertiser in the execution of the corresponding app.

19. The computer system of claim 18, wherein the advertisement services component is configured to charge the advertiser a completed transaction charge when the completion of a transaction is detected.

20. The computer system of claim 18, wherein the advertisement services component is configured to charge the advertiser a “no transaction” charge when execution of the corresponding app is detected without detecting the completion of a transaction between the user and an advertiser.
